(19) United States
(12) Patent Application Publication
(10) Pub. No.: US 2005/0213720 A1
(43) Pub. Date: Sep. 29, 2005

(54) Communication terminal device and communication method

(75) Inventor: Shinji Kawasaki, Joyo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/086,752

(22) Filed: Mar. 23, 2005

(30) Foreign Application Priority Data
Mar. 26, 2004 (JP) 2004-092688

(51) Int. Cl. H04M 11/00

(52) U.S. Cl. 379/100.15; 379/100.05; 379/100.01

(57) ABSTRACT

The present invention relates to a communication terminal device and a communication method which access a folder of a terminal connected to a network. When a selection is made by an operation key, in accordance with a path associated with the selected operation key, image data is written into the folder or data is fetched from the folder.

### BACKGROUND OF THE INVENTION

1. Field of the Invention

The present invention relates to a communication terminal device and a communication method, and in particular, relates to a communication terminal device and a communication method which can access a folder included in a terminal connected to a network.

2. Description of Related Art

Accompanying a spread of a network technology, information equipment such as a facsimile machine and a Multi Function Peripheral (MFP) is also connected to a network. Such a facsimile machine includes a general facsimile communication function by a Group 3 (G3) method or the like, and also an e-mail transmitting function, an e-mail receiving function and an Internet facsimile function or the like. According to the Internet facsimile function, the facsimile machine transmits or receives image data of an original document or the like via the network. The facsimile machine can transmit and receive information to and from another facsimile machine, a computer and an Internet facsimile machine or the like.

As described above, by being connected to the network, the facsimile machine can share information with another terminal such as a computer connected to the same network. The facsimile machine can transmit and receive data to and from another terminal connected to the same network.

A conventional facsimile machine or a telephone set can register a telephone number of a facsimile transmission destination or a telephone number of another party of telephone communication as one-touch dial information.

However, as described above, the facsimile machine is recently used not only for a facsimile transmission or a telephone. The facsimile machine also shares data with a plurality of terminals such as computers and functions as a server of the plurality of terminals.

### SUMMARY OF THE INVENTION

The present invention has been made in consideration of the above-described circumstances. An advantage of the present invention is to improve the convenience of access to a folder in a communication terminal device which can access a folder included in a terminal connected to a network.

According to a first aspect of the present invention, a communication terminal device can access a folder included in a terminal connected to a network. The communication terminal device includes an operation key associated with a path to the folder. The communication terminal device accepts a selection of the operation key, and by the selection of the operation key, accesses the folder associated with the operation key.

Accordingly, the communication terminal device can easily and promptly access a desired folder included in the terminal connected to the communication terminal device. The communication terminal device can be a facsimile machine. In this case, the operation key can be a one-touch key.

According to a second aspect of the present invention, the communication terminal device can scan an original document, convert the original document into electronic data and accept a transfer instruction of the electronic data. When an instruction accepting unit accepts the transfer instruction of the electronic data and the operation key is operated, the communication terminal device can transfer the data to a folder associated with the operation key.

Accordingly, just by selecting the operation key and carrying out the transfer instruction, the data can be transferred to a desired folder included in the terminal connected to the communication terminal device. As a result, by associating a folder that frequently transfers the data with the operation key, convenience of a user of the communication terminal device can be improved.

According to a third aspect of the present invention, the communication terminal device can display data and accept a browsing request of the data. The communication terminal device can accept the browsing request of the data, and when the operation key is selected, display the data included in the folder associated with the operation key.

Accordingly, just by selecting the operation key and carrying out a browsing request instruction, the user can browse the data of a desired folder included in the terminal connected to the communication terminal device. As a result, convenience of the user of the communication terminal device can be improved.

According to a fourth aspect of the present invention, a communication terminal device can access a folder included in a terminal connected to a network. The communication terminal device includes an operation key which is associated with a path to the folder. The communication terminal device accepts a selection of the operation key, accepts a processing mode to the folder and accepts a selection of the processing mode. In addition, when the operation key is selected, the communication terminal device can access the folder associated with the operation key and carry out a processing associated with the processing mode.

Accordingly, the communication terminal device can easily access a desired folder included in the terminal connected to the communication terminal device. According to a circumstance, the communication terminal device can carry out various processing to the folder and convenience of the user can be improved. Either one of the selection of the operation key and the acceptance of the processing mode can be carried out first.

### BRIEF DESCRIPTION OF THE SEVERAL VIEWS OF THE DRAWINGS

FIG. 1 is a block diagram showing a network configuration of a communication terminal device according to an embodiment of the present invention.

FIG. 2 is a detailed functional block diagram showing a control unit of the communication terminal device.

FIG. 3 shows a data structure of a registration information storage unit.

FIG. 4 is a flowchart showing a process of a facsimile machine.

### DETAILED DESCRIPTION OF THE INVENTION

With reference to the drawings, an embodiment of the present invention will be described. In the present embodiment, a communication terminal device is a facsimile machine. The facsimile machine includes a one-touch registering function and stores a one-touch key and a path to a folder of a terminal connected to the facsimile machine via a network by associating to one another.

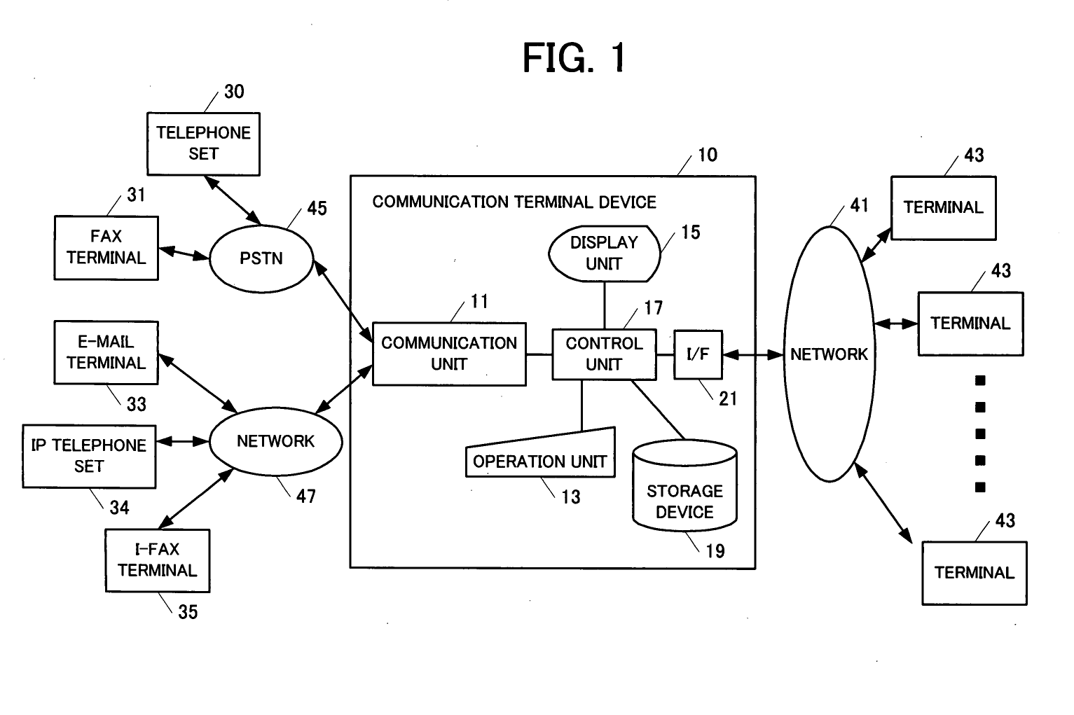

FIG. 1 is a block diagram showing a network configuration of the facsimile machine according to an embodiment of the present invention. A facsimile machine 10 is connected to a plurality of terminals 43 via a network 41. The network 41 is, for example, a Local Area Network (LAN). Each of the terminals 43 is a personal computer or the like. A user of the facsimile machine 10 can browse data included in a folder of a terminal 43 or transfer scan data scanned by the facsimile machine 10 to the folder of the terminal 43.

The facsimile machine 10 can carry out communication with another communication terminal device by a plurality of communication methods. For example, the facsimile machine 10 carries out communication with a telephone set 30 and a facsimile terminal 31 via a Public Switched Telephone Network (PSTN) 45. The facsimile machine 10 also carries out communication with an e-mail terminal 33, an Internet Protocol (IP) telephone set 34 and an Internet facsimile terminal 35 via a network 47 such as the Internet.

Although not shown in the drawing, the facsimile machine 10 can carry out communication with a mobile phone terminal. In this case, the facsimile machine 10 carries out communication via a wireless base station and a wireless relay station.

In case the facsimile machine 10 carries out communication with another communication terminal device, the facsimile machine 10 designates address information of a destination. The address information of the destination differs according to a type of each communication terminal device. For example, the address information is a telephone number, an e-mail address, an IP telephone number and a Uniform Resource Locator (URL).

The facsimile machine 10 includes a communication unit 11, an operation unit 13, a display unit 15, a control unit 17, a storage device 19 and an interface unit 21. For example, the facsimile machine 10 is a network facsimile machine or a MFP. In FIG. 1, a structure of a part unrelated to a subject matter of the present invention is omitted. For example, a document scanner unit, an image processing unit and a printer unit of a facsimile machine, and a handset and an audio frequency signal processing unit of a telephone set are not shown in the drawing.

Each constituent element of the facsimile machine 10 is realized by any combination of hardware and software primarily by a Central Processing Unit (CPU) of any computer, a memory, a program which realizes the constituent elements shown in the drawing loaded to the memory, a storage unit such as a hard disk drive which stores the program, and an interface for establishing a connection with the network. It is to be understood by those skilled in the art that various changes and modifications can be made for methods and devices for realizing each constituent element of the facsimile machine 10. Each of the drawings to be described hereinafter shows blocks representing units of function, instead of units of hardware.

The communication unit 11 carries out communication with the facsimile terminal 31, the e-mail terminal 33 and the Internet facsimile terminal 35.

The operation unit 13 accepts various settings and inputs made by the user of the facsimile machine 10. For example, the operation unit 13 is a push switch, a toggle switch, a keyboard or a touch panel. In the present embodiment, the operation unit 13 includes a plurality of one-touch keys.

The display unit 15 displays various pieces of information, an operation screen and an operation or a status of the facsimile machine 10. For example, a lamp, a Light Emitting Diode (LED), a Cathode Ray Tube (CRT) monitor, a Liquid Crystal Display (LCD) or the like is applied to the display unit 15. The display unit 15 can display data included in a folder of the terminal 43.

The control unit 17 controls various elements of the facsimile machine 10 and the entire facsimile machine 10. A configuration of the control unit 17 will be described later.

The storage device 19 stores transmission destination information of facsimile or e-mail and scan data scanned by the document scanner unit (not shown) or the like.

The interface unit 21 enables communication to be carried out with a plurality of terminals 43 connected via the network 41.

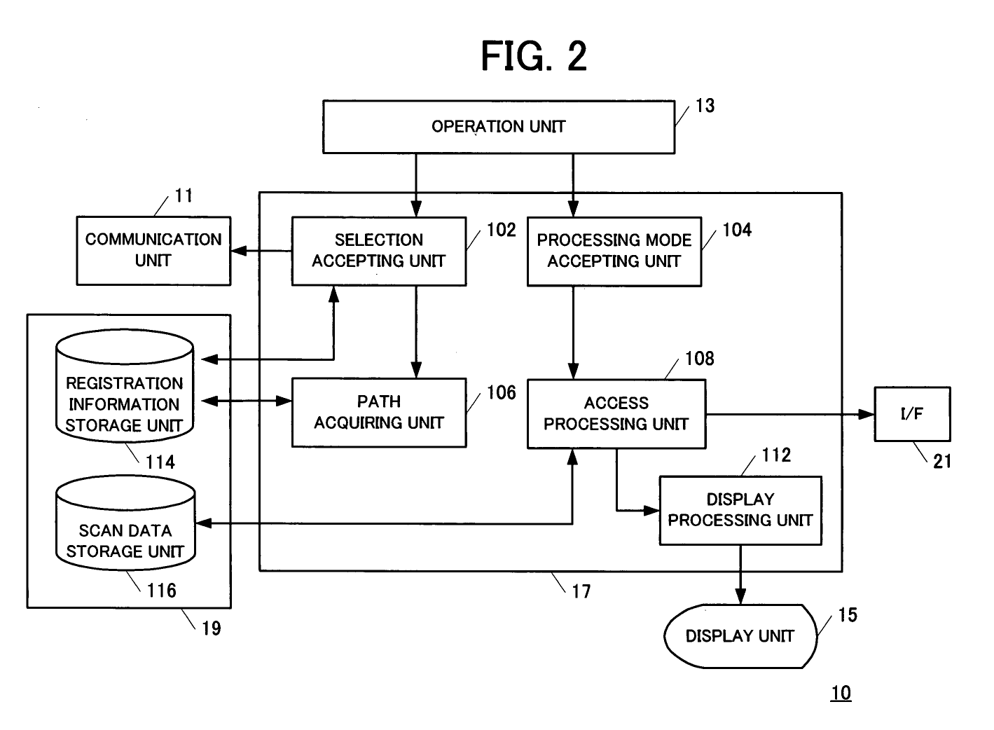

FIG. 2 is a detailed functional block diagram of the control unit 17 of the facsimile machine 10. The control unit 17 includes a selection accepting unit 102, a processing mode accepting unit 104, a path acquiring unit 106, an access processing unit 108 and a display processing unit 112. The storage device 19 includes a registration information storage unit 114 and a scan data storage unit 116.

When the user selects and presses one of the one-touch keys, the selection accepting unit 102 accepts the selection of the one-touch key. When the one-touch key is selected, the selection accepting unit 102 refers to the registration information storage unit 114 and determines whether or not a path to any one of folders is associated with the selected one-touch key. The path acquiring unit 106 acquires the path associated with the selected one-touch key accepted by the selection accepting unit 102. The access processing unit 108 accesses a prescribed folder by the path acquired by the path acquiring unit 106.

The processing mode accepting unit 104 accepts a selection of a processing mode from the user via the operation unit 13. The processing mode includes a transfer of the scan data and a browsing of the data included in the folder of the terminal 43.

The display processing unit 112 carries out a processing for displaying on the display unit 15, data acquired by the access processing unit 108.

The scan data storage unit 116 temporarily stores the scan data scanned by the scanner unit (not shown). The registration information storage unit 114 stores a one-touch key and registration information associated with each one-touch key.

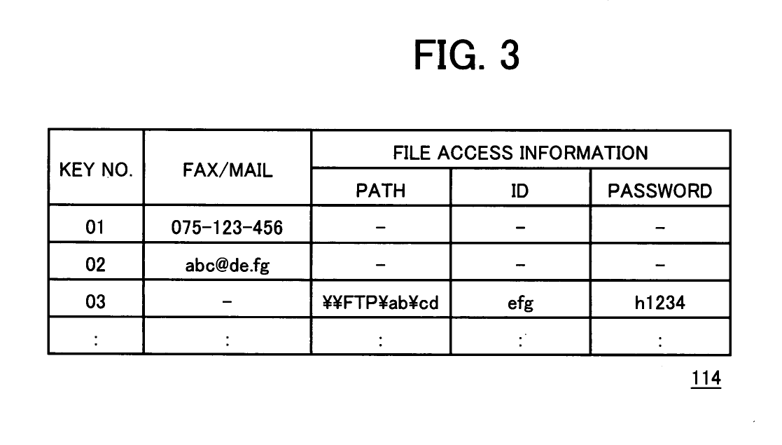

FIG. 3 shows a data structure of the registration information storage unit 114. The registration information storage unit 114 includes a “Key No.” column, a “Fax/Mail” column and a “File access information” column. The file access information column includes a path, an ID and a password columns.

For example, for a one-touch key of a Key No. “01”, a telephone number “075-123-456” is associated. When the user selects the one-touch key “01”, the selection accepting unit 102 refers to the registration information storage unit 114 and acquires the telephone number “075-123-456” associated with the one-touch key “01”. The facsimile machine 10 transmits a facsimile to the telephone number in accordance with another instruction from the user.

For a one-touch key of a Key No. “02”, an e-mail address “abc@de.fg” is associated. When the user selects the one-touch key “02”, the selection accepting unit 102 refers to the registration information storage unit 114 and acquires the e-mail address “abc@de.fg” associated with the one-touch key “02”. The facsimile machine 10 transmits an e-mail to the e-mail address in accordance with another instruction from the user.

For a one-touch key of a Key No. “03”, a path “¥¥FTP¥ab¥cd” is associated. “¥¥FTP¥ab¥cd” is a path to a folder “cd” in a folder “ab” of a terminal having a terminal name “FTP”. The one-touch key “03” is also associated with an ID “efg” and a password “h1234” for accessing this folder.

When the user selects the one-touch key “03”, the selection accepting unit 102 refers to the registration information storage unit 114. The path acquiring unit 106 acquires the path “¥¥FTP¥ab¥cd” associated with the one-touch key “03”. The access processing unit 108 accesses the path acquired by the path acquiring unit 106. In case an ID and a password are necessary for accessing the folder “cd”, the path acquiring unit 106 also acquires the ID and the password. The access processing unit 108 transmits the ID and the password to a target terminal and accesses the folder “cd”.

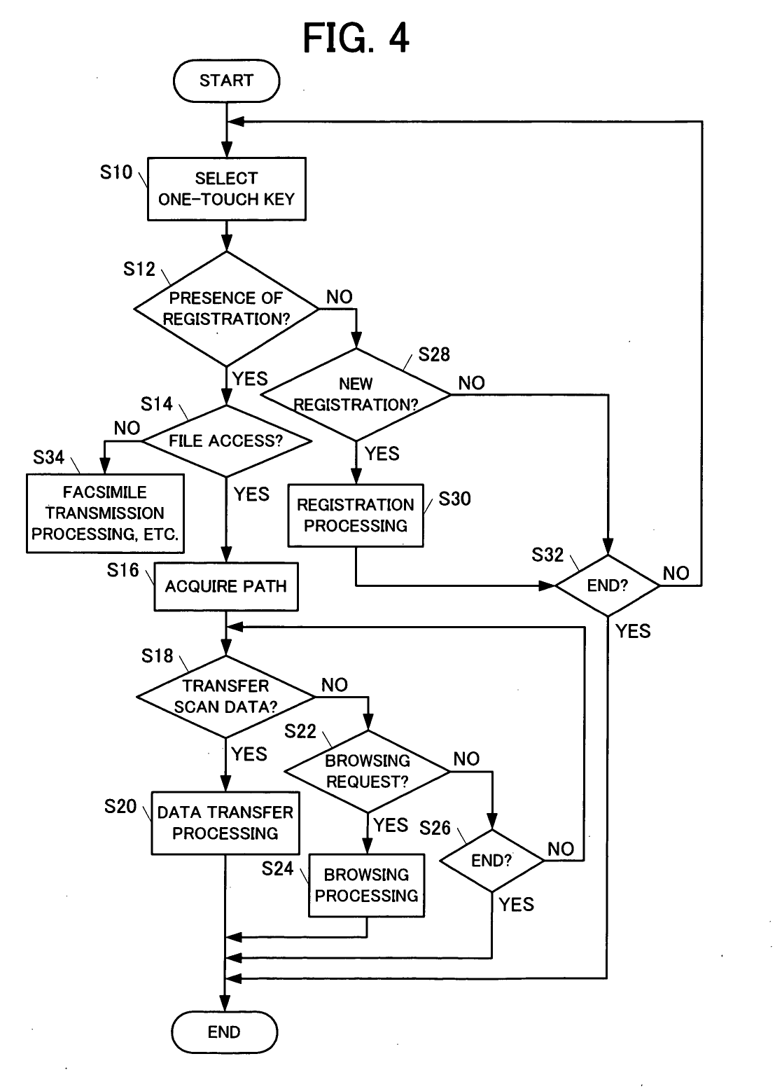

FIG. 4 is a flowchart showing a process of the facsimile machine 10. First, when the user selects one of the one-touch keys, the selection accepting unit 102 accepts the selection of the one-touch key (step S10). The selection accepting unit 102 refers to the registration information storage unit 114 and determines a presence or an absence of registration information associated with the one-touch key (step S12). In case of the presence of the registration information associated with the one-touch key (YES at step S12), the selection accepting unit 102 determines whether or not the registration information is access information to the file (step S14). In case the registration information is the access information to the file (YES at step S14), the path acquiring unit 106 acquires a path to the file (step S16).

Next, the processing mode accepting unit 104 accepts a selection of a processing mode from the user. In case the user selects a transfer of the scan data (YES at step S18), the access processing unit 108 accesses a desired file in accordance with the path acquired by the path acquiring unit 106, fetches desired scan data from the scan data storage unit 116 and transfers the scan data (step S20).

Meanwhile, in case the user selects a browsing of the file (NO at step S18 and YES at step S22), the access processing unit 108 accesses a desired file in accordance with the path acquired by the path acquiring unit 106 and acquires data included in the file. The display processing unit 112 carries out a processing for displaying on the display unit 15, the data acquired by the access processing unit 108 (step S24).

For example, in case the user does not select a transfer of the scan data or a browsing of the file within a prescribed period of time (NO at step S18 and NO at step S22), an inquiry is made to the user via the display unit 15 as to whether or not to end the processing (step S26). In case the user selects to end the processing (YES at step S26), the processing ends. Meanwhile, at step S26, in case the user does not select to end the processing (NO at step S26), the process returns to step S18 and the processing mode accepting unit 104 goes on a standby until a processing mode is selected by the user.

At step S12, in case of the absence of the registration information associated with the one-touch key selected by the user (NO at step S12), the selection accepting unit 102 inquires the user as to whether or not to carry out a new registration (step S28). In case the user selects to carry out a new registration (YES at step S28), the control unit 17 carries out a registration processing (step S30). Meanwhile, at step S28, in case the user does not select to carry out a new registration (NO at step S28), the control unit 17 inquires via the display unit 15, whether or not to end the processing (step S32). In case the user selects to end the processing (YES at step S32), the control unit 17 ends this processing.

At step S32, in case the user does not select to end the processing (NO at step S32), the process returns to step S10 and the control unit 17 goes on standby until a new one-touch key is selected. At step S14, in case the registration information associated with the one-touch key selected by the user is not an access to the file (NO at step S14), the control unit 17 carries out a facsimile transmission processing or the like in accordance with a facsimile number or an e-mail address associated with the one-touch key. This processing is the same processing as a general facsimile machine. Therefore, a detailed description will be omitted.

A preferred embodiment of the present invention has been described. However, the present invention is not limited to the above-described embodiment. It is to be understood by those skilled in the art that there are variations to the embodiment without departing from the scope of the present invention.

In the above-described embodiment, a facsimile number and an e-mail address are also associated with the one-touch key. However, the one-touch key can be associated with only a path to a file of the terminal 43 connected to the facsimile machine 10.

In the above-described embodiment, after the user selects a one-touch key, a selection of a processing mode made by the user is accepted. However, as another embodiment, after accepting a selection of a processing mode from the user, the control unit can accept a selection of the one-touch key. In this case, by the selection of the one-touch key, the path acquiring unit 106 acquires the path associated with the one-touch key. The access processing unit 108 accesses a prescribed folder by the path acquired by the path acquiring unit 106 and carries out a processing according to the processing mode selected by the user.

1. A communication terminal device which can access a folder of a terminal connected to a network, the communication terminal device comprising:
an operation key means associated with a path to a folder;
a selection accepting means for accepting a selection of an operation key; and
means for accessing a folder associated with the operation key in accordance with the selection of the selection accepting means.

2. The communication terminal device according to claim 1, further comprising a registration information storing means for storing the path of the folder associated with the operation key.

3. The communication terminal device according to claim 2, further comprising:
means for scanning an image of an original document and converting the original document into image data;
an instruction accepting means for accepting an instruction of a transfer of the image data of the original document; and
means for transferring the image data to the selected folder;
wherein when the instruction accepting means accepts the instruction of the transfer and the operation key means is selected, the means for accessing fetches from the registration information storing means, the path associated with the selected operation key means, and transfers the image data to the folder.

4. The communication terminal device according to claim 2, further comprising:
means for displaying data; and
a browsing request accepting means for accepting a browsing request of the data;
wherein when the browsing request accepting means accepts the browsing request of the data and the operation key means is selected, the means for accessing displays on the means for displaying, the data included in the folder associated with the selected operation key means.

5. The communication terminal device according to claim 2, further comprising a path registering means, wherein in case the operation key means is operated under a state in which a corresponding path is not stored in the registration information storing means, the path registering means stores the corresponding path in the registration information storing means.

6. The communication terminal device according to claim 2, further comprising means for carrying out data communication in case the registration information storing means stores communication destination information and not path information corresponding to a key operated by the operation key means.

7. A communication terminal device which can access a folder of a terminal connected to a network, comprising:
an operation key means associated with a path to a folder;
a selection accepting means for accepting a selection of the operation key means;
a mode accepting means for accepting a processing mode to the folder; and
means for processing which, in case the mode accepting means accepts a selection of the processing mode, accesses a folder associated with a key selected by the operation key means and carries out a processing according to the processing mode.

8. The communication terminal device according to claim 7, further comprising a registration information storing means for storing a path of the folder associated with the operation key.

9. The communication terminal device according to claim 8, further comprising:
means for scanning an image of an original document and converting the original document into image data;
an instruction accepting means for accepting an instruction of a transfer of the image data of the original document;
means for transferring the image data to the selected folder;
means for displaying data; and
a browsing request accepting means for accepting a browsing request of the data;
wherein the means for processing includes a first processing mode and a second processing mode, and under the first processing mode, the image data obtained by the means for scanning is transferred to the selected folder by the means for transferring in accordance with the instruction of the instruction accepting means, and under the second processing mode, the browsing request accepting means fetches the data from the selected folder and displays the fetched data on the means for displaying.

10. The communication terminal device according to claim 8, further comprising a path registering means, wherein in case the operation key means is operated under a state in which a corresponding folder is not stored in the registration information storing means, the path registering means stores the path of the folder in the registration information storing means.

11. The communication terminal device according to claim 8, further comprising means for carrying out data communication in case the registration information storing means registers communication destination information and not path information of the folder corresponding to a key operated by the operation key means.

12. A communication method for accessing a folder of a terminal connected to a network, the communication method comprising the steps of:
operating an operation key and accepting a selection of the operation key;
acquiring a path of a folder associated with the operation key in accordance with the accepted selection; and
accessing the folder in accordance with the path.

13. The communication method according to claim 12, further comprising the step of writing stored image data into the accessed folder.

14. The communication method according to claim 13, further comprising the steps of:
scanning an image of an original document and generating image data; and
storing the generated image data.

15. The communication method according to claim 12, further comprising the step of receiving data of the accessed folder.

16. The communication method according to claim 15, further comprising the step of displaying the received data.

17. The communication method according to claim 12, further comprising the steps of:
accepting a designation of a mode;
determining whether the accepted mode is one of a first mode and a second mode; and
in case the mode is the first mode,
scanning an image of an original document and storing image data; and
writing the stored image data into the accessed folder; and
in case the mode is the second mode,
receiving data of the accessed folder; and
displaying the received data.

18. The communication method according to claim 12, further comprising the step of, in case a path of the folder associated with the selected operation key is not registered, registering the path for the operation key.

19. The communication method according to claim 12, further comprising the steps of:
determining whether information associated with the operated operation key is a path; and
in case information that is not the path is registered, carrying out communication with the information as destination information.

20. The communication method according to claim 19, wherein the communication is one of facsimile communication and electronic mail communication.
